(19) United States
(12) Patent Application Publication
(10) Pub. No.: US 2018/0357278 A1
(43) Pub. Date: Dec. 13, 2018

(54) PROCESSING AGGREGATE QUERIES IN A GRAPH DATABASE

(71) Applicant: LinkedIn Corporation, Sunnyvale, CA (US)

(72) Inventors: Walaa Eldin M. Moustafa, Santa Clara, CA (US); Andrew J. Carter, Mountain View, CA (US); Andrew Rodriguez, Palo Alto, CA (US); Scott M. Meyer, Berkeley, CA (US)

(73) Assignee: LinkedIn Corporation, Sunnyvale, CA (US)

(21) Appl. No.: 15/618,368

(22) Filed: Jun. 9, 2017

(51) Int. Cl. G06F 17/30

(52) U.S. Cl. CPC G06F 17/30451; G06F 17/30463; G06F 17/30958

(57) ABSTRACT

The disclosed embodiments provide a system for processing queries of a graph database. During operation, the system executes one or more processes for providing the graph database storing a graph, wherein the graph includes a set of nodes, a set of edges between pairs of nodes in the set of nodes, and a set of predicates. Next, the system obtains, from the query, an aggregation by a first attribute and a grouping by a second attribute. The system then uses the second attribute to generate a set of groupings of records in the graph database. For each grouping in the set of groupings, the system applies the aggregation to the first attribute in a subset of the records in the grouping to generate an aggregation result. Finally, the system uses the aggregation result to provide a response to the query.

### RELATED APPLICATIONS

The subject matter of this application is also related to the subject matter in a co-pending non-provisional application by inventors SungJu Cho, Jiahong Zhu, Yinyi Wang, Roman A. Averbukh, Scott M. Meyer, Shyam Shankar, Qingpeng Niu and Karan K. Parikh, entitled “Index Structures for Graph Databases,” having Ser. No. 15/058,028 and filing date 1 Mar. 2016 (Attorney Docket No. LI-P1662.LNK.US).

### BACKGROUND

### Field

The disclosed embodiments relate to graph databases. More specifically, the disclosed embodiments relate to techniques for processing aggregate queries in a graph database.

### Related Art

Data associated with applications is often organized and stored in databases. For example, in a relational database data is organized based on a relational model into one or more tables of rows and columns, in which the rows represent instances of types of data entities and the columns represent associated values. Information can be extracted from a relational database using queries expressed in a Structured Query Language (SQL).

In principle, by linking or associating the rows in different tables, complicated relationships can be represented in a relational database. In practice, extracting such complicated relationships usually entails performing a set of queries and then determining the intersection of or joining the results. In general, by leveraging knowledge of the underlying relational model, the set of queries can be identified and then performed in an optimal manner.

However, applications often do not know the relational model in a relational database. Instead, from an application perspective, data is usually viewed as a hierarchy of objects in memory with associated pointers. Consequently, many applications generate queries in a piecemeal manner, which can make it difficult to identify or perform a set of queries on a relational database in an optimal manner. This can degrade performance and the user experience when using applications.

Various approaches have been used in an attempt to address this problem, including using an object-relational mapper, so that an application effectively has an understanding or knowledge about the relational model in a relational database. However, it is often difficult to generate and to maintain the object-relational mapper, especially for large, real-time applications.

Alternatively, a key-value store (such as a NoSQL database) may be used instead of a relational database. A key-value store may include a collection of objects or records and associated fields with values of the records. Data in a key-value store may be stored or retrieved using a key that uniquely identifies a record. By avoiding the use of a predefined relational model, a key-value store may allow applications to access data as objects in memory with associated pointers (i.e., in a manner consistent with the application's perspective). However, the absence of a relational model means that it can be difficult to optimize a key-value store. Consequently, it can also be difficult to extract complicated relationships from a key-value store (e.g., it may require multiple queries), which can also degrade performance and the user experience when using applications.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows a system for processing queries of a graph database in accordance with the disclosed embodiments.

FIG. 4 shows the processing of a query of a graph database in accordance with the disclosed embodiments.

FIG. 5 shows a flowchart illustrating the processing of a query of a graph database in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

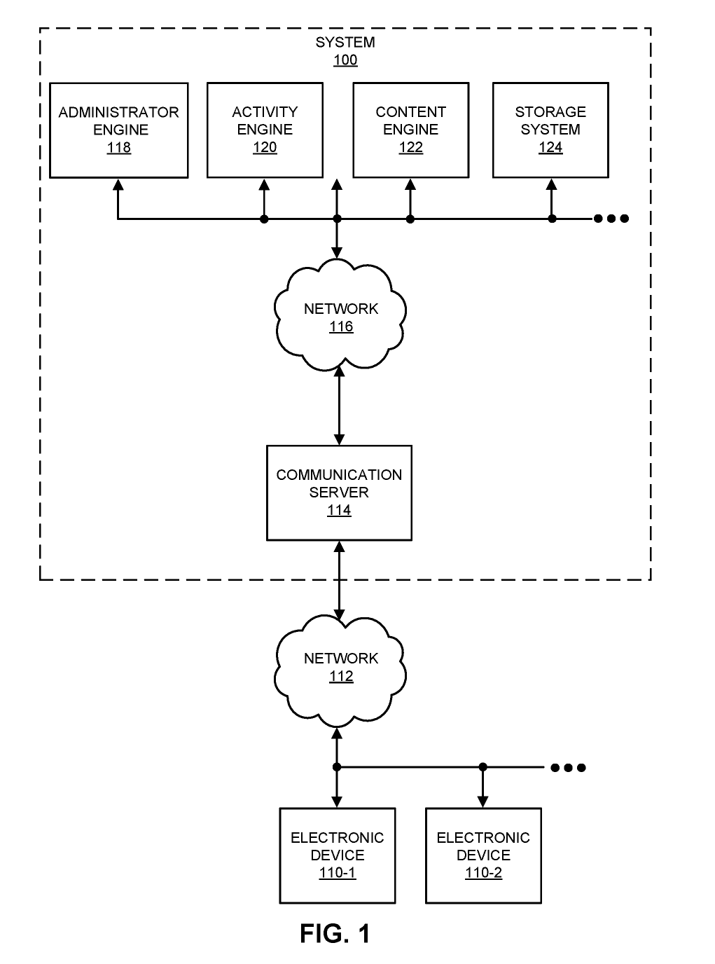

The disclosed embodiments provide a method, apparatus and system for processing queries of a graph database. A system 100 for performing a technique described herein is shown in FIG. 1. In this system, users of electronic devices 110 may use a service that is, at least in part, provided using one or more software products or applications executing in system 100. As described further below, the applications may be executed by engines in system 100.

Moreover, the service may, at least in part, be provided using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a network of users), such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network. For example, administrator engine 118 may handle user accounts and user profiles, activity engine 120 may track and aggregate user behaviors over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices (e.g., a large-scale distributed storage system).

Note that each of the users of the social network may have an associated user profile that includes personal and professional characteristics and experiences, which are sometimes collectively referred to as ‘attributes’ or ‘characteristics.’ For example, a user profile may include demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the social network (such as users, companies, etc.). For example, the nodes may correspond to attributes, properties or characteristics of the users.

As noted previously, it may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner. For example, when an application requests data associated with a complicated relationship (which may involve two or more edges, and which is sometimes referred to as a ‘compound relationship’), a set of queries may be performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may be time-consuming. This degraded performance may, in turn, degrade the user experience when using the applications and/or the social network.

To address these problems, storage system 124 may include a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

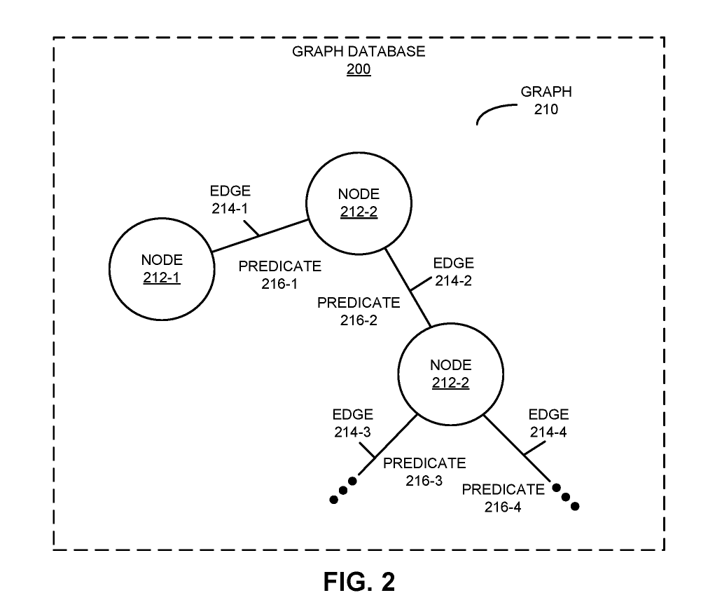

FIG. 2 presents a block diagram illustrating a graph 210 stored in a graph database 200 in system 100 (FIG. 1). Graph 210 includes nodes 212, edges 214 between nodes 212, and predicates 216 (which are primary keys that specify or label edges 214) to represent and store the data with index-free adjacency, so that each node 212 in graph 210 includes a direct edge to its adjacent nodes without using an index lookup.

Note that graph database 200 may be an implementation of a relational model with constant-time navigation (i.e., independent of the size N), as opposed to varying as log(N). Moreover, all the relationships in graph database 200 may be first class (i.e., equal). In contrast, in a relational database, rows in a table may be first class, but a relationship that involves joining tables may be second class. Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that maintains the structure (i.e., nodes, edges) of the subset of graph 210.

The graph-storage technique may include embodiments of methods that allow the data associated with the applications and/or the social network to be efficiently stored and retrieved from graph database 200. Such methods are described in U.S. Pat. No. 9,535,963 (issued 3 Jan. 2017), by inventors Srinath Shankar, Rob Stephenson, Andrew Carter, Maverick Lee and Scott Meyer, entitled “Graph-Based Queries,” which is incorporated herein by reference.

Referring back to FIG. 1, the graph-storage techniques described herein may allow system 100 to efficiently and quickly (e.g., optimally) store and retrieve data associated with the applications and the social network without requiring the applications to have knowledge of a relational model implemented in graph database 200. Consequently, the graph-storage techniques may improve the availability and the performance or functioning of the applications, the social network and system 100, which may reduce user frustration and which may improve the user experience. Therefore, the graph-storage techniques may increase engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

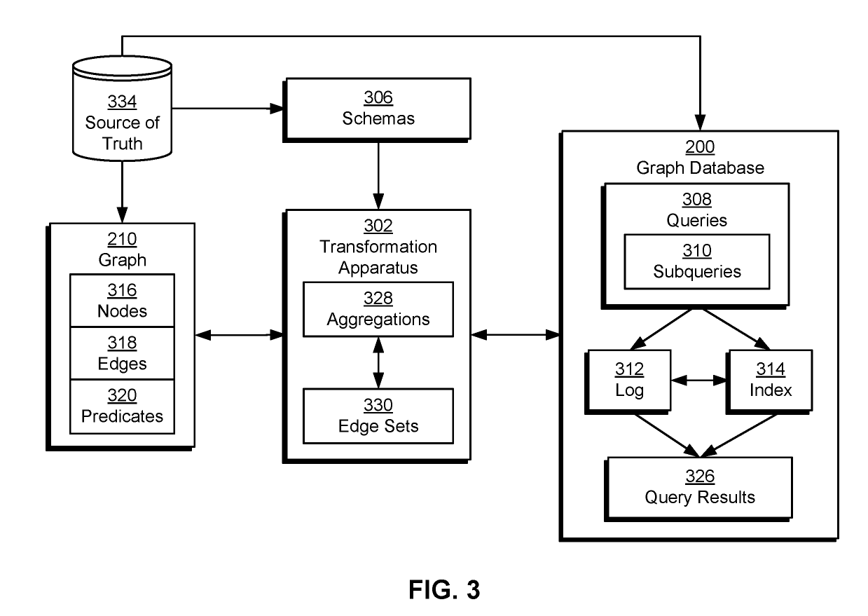

In one or more embodiments, graph database 200 includes functionality to transform and evaluate aggregations associated with nodes, edges, and/or other components of the graph database. As shown in FIG. 3, graph 210 and one or more schemas 306 associated with graph 210 may be obtained from a source of truth 334 for graph database 200. For example, graph 210 and schemas 306 may be retrieved from a relational database, distributed filesystem, and/or other storage mechanism providing the source of truth.

As mentioned above, graph 210 may include a set of nodes 316, a set of edges 318 between pairs of nodes, and a set of predicates 320 describing the nodes and/or edges. Each edge in the graph may be specified in a (subject, predicate, object) triple. For example, an edge denoting a connection between two members named “Alice” and “Bob” may be specified using the following statement:

Edge(“Alice”, “ConnectedTo”, “Bob”).

In the above statement, “Alice” is the subject, “Bob” is the object, and “ConnectedTo” is the predicate. A period following the “Edge” statement may denote an assertion that is used to write the edge to graph database 200. Conversely, the period may be replaced with a question mark to read any edges that match the subject, predicate, and object from the graph database:

Edge(“Alice”, “ConnectedTo”, “Bob”)?

Moreover, a subsequent statement may modify the initial statement with a tilde to indicate deletion of the edge from graph database 200:

Edge˜(“Alice”, “ConnectedTo”, “Bob”).

In addition, specific types of edges and/or complex relationships in graph 210 may be defined using schemas 306. Continuing with the previous example, a schema for employment of a member at a position within a company may be defined using the following:

DefPred(“employ/company”, “1”, “node”, “0”, “node”).
DefPred(“employ/member”, “1”, “ node”, “0”, “node”).
DefPred(“employ/start”, “1”, “node”, “0”, “date”).
DefPred(“employ/end_date”, “1”, “node”, “0”, “date”).
M2C@(e, memberId, companyId, start, end) :-

Edge(e, “employ/member”, memberId),
Edge(e, “employ/company”, companyId),
Edge(e, “employ/start”, start),
Edge(e, “employ/end_date”, end)

In the above schema, a compound structure for the employment is denoted by the “@” symbol and has a compound type of “M2C.” The compound is also represented by four predicates and followed by a rule with four edges that use the predicates. The predicates include a first predicate representing the employment at the company (e.g., “employ/company”), a second predicate representing employment of the member (e.g., “employ/member”), a third predicate representing a start date of the employment (e.g., “employ/start”), and a fourth predicate representing an end date of the employment (e.g., “employ/end date”). In the rule, the first edge uses the second predicate to specify employment of a member represented by “memberId,” and the second edge uses the first predicate to employment to a company represented by “companyId.” The third edge of the rule uses the third predicate to specify a “start” date of the employment, and the fourth edge of the rule uses the fourth predicate to specify an “end” date of the employment. All four edges share a common subject denoted by “e,” which functions as a hub node that links the edges to form the compound relationship.

In another example, a compound relationship representing endorsement of a skill in an online professional network may include the following schema:

DefPred(“endorser”, “1”, “node”, “0”, “node”).
DefPred(“endorsee”, “1”, “ node”, “0”, “node”).
DefPred(“skill”, “1”, “node”, “0”, “node”).
Endorsement@(h, Endorser, Endorsee, Skill) :-

Edge(h, “endorser”, Endorser),
Edge(h, “endorsee”, Endorsee),
Edge(h, “skill”, Skill).

In the above schema, the compound relationship is declared using the “@” symbol and specifies “Endorsement” as a compound type (i.e., data type) for the compound relationship. The compound relationship is represented by three predicates defined as “endorser,” “endorsee,” and “skill.” The “endorser” predicate may represent a member making the endorsement, the “endorsee” predicate may represent a member receiving the endorsement, and the “skill” predicate may represent the skill for which the endorsement is given. The declaration is followed by a rule that maps the three predicates to three edges. The first edge uses the first predicate to identify the endorser as the value specified in an “Endorser” parameter, the second edge uses the second predicate identify the endorsee as the value specified in an “Endorsee” parameter, and the third edge uses the third predicate to specify the skill as the value specified in a “Skill” parameter. All three edges share a common subject denoted by “h,” which functions as a hub node that links the edges to form the compound relationship. Consequently, the schema may declare a trinary relationship for an “Endorsement” compound type, with the relationship defined by identity-giving attributes with types of “endorser,” “endorsee,” and “skill” and values attached to the corresponding predicates.

Consequently, compounds stored in graph database 200 may model complex relationships (e.g., employment of a member at a position within a company) using a set of basic types (i.e., binary edges 318) in graph database 200. More specifically, each compound may represent an n-ary relationship in the graph, with each “component” of the relationship identified using the predicate and object (or subject) of an edge. A set of “n” edges that model the relationship may then be linked to the compound using a common subject (or object) that is set to a hub node representing the compound. In turn, new compounds may dynamically be added to graph database 200 without changing the basic types used in graph database 200 by specifying relationships that relate the compound structures to the basic types in schemas 306.

Graph 210 and schemas 306 may additionally be used to populate a graph database 200 for processing queries 308 against the graph. More specifically, a representation of nodes 316, edges 318, and predicates 320 may be obtained from source of truth 334 and stored in a log 312 in the graph database. Lock-free access to the graph database may be implemented by appending changes to graph 210 to the end of the log instead of requiring modification of existing records in the source of truth. In turn, the graph database may provide an in-memory cache of log 312 and an index 314 for efficient and/or flexible querying of the graph.

Nodes 316, edges 318, and predicates 320 may be stored as offsets in log 312. For example, the exemplary edge statement for creating a connection between two members named “Alice” and “Bob” may be stored in a binary log 312 using the following format:

| | |
|---|---|
| 256 | Alice |
| 261 | Bob |
| 264 | ConnectedTo |
| 275 | (256, 264, 261) |

In the above format, each entry in the log is prefaced by a numeric (e.g., integer) offset representing the number of bytes separating the entry from the beginning of the log. The first entry of “Alice” has an offset of 256, the second entry of “Bob” has an offset of 261, and the third entry of “ConnectedTo” has an offset of 264. The fourth entry has an offset of 275 and stores the connection between “Alice” and “Bob” as the offsets of the previous three entries in the order in which the corresponding fields are specified in the statement used to create the connection (i.e., Edge(“Alice”, “ConnectedTo”, “Bob”)).

Because the ordering of changes to graph 210 is preserved in log 312, offsets in log 312 may be used as representations of virtual time in graph 210. More specifically, each offset may represent a different virtual time in graph 210, and changes in the log up to the offset may be used to establish a state of graph 210 at the virtual time. For example, the sequence of changes from the beginning of log 312 up to a given offset that is greater than 0 may be applied, in the order in which the changes were written, to construct a representation of graph 210 at the virtual time represented by the offset.

Graph database 200 may also include an in-memory index 314 that enables efficient lookup of edges 318 by subject, predicate, object, and/or other keys or parameters 310. Index structures for graph databases are described in a co-pending non-provisional application by inventors SungJu Cho, Jiahong Zhu, Yinyi Wang, Roman Averbukh, Scott Meyer, Shyam Shankar, Qingpeng Niu and Karan Parikh, entitled “Index Structures for Graph Databases,” having Ser. No. 15/058,028 and filing date 1 Mar. 2016 (Attorney Docket No. LI-P1662.LNK.US), which is incorporated herein by reference.

In one or more embodiments, the system of FIG. 3 includes functionality to process queries 308 containing aggregations 328 of nodes 316, edges 318, predicates 320, and/or other attributes in graph database 200. Aggregations 328 may include counts (e.g., a total number of records matching a query), sums (e.g., summing a numeric attribute in the records), minimums, maximums, averages, percentiles, and/or other metrics calculated from multiple records in graph database 200. In addition, a query that includes an aggregation by one attribute may also specify grouping of the records by another attribute. For example, a schema for counting endorsements for each member may include the following:

EndorsementCount(x, count<z>) :-

Edge(h, “endorsee”, x),
Edge(h, “endorser”, y),
Edge(h, “skill”, z).

In the above schema, the “EndorsementCount” rule is used to generate, for each “endorsee” specified by x, a “count” of the “skill” attribute. Thus, the rule may group edges in the “Endorsement” compound by “endorsee” before counting, for each “endorsee,” the number of edges with “skill” as a predicate.

In addition, queries 308 of graph database 200 may include subqueries 310 that are nested in other subqueries. As a result, the sub-result of a given subquery may be used as input for processing another subquery in which the first subquery is nested. For example, the following statement may include a series of nested subqueries 310:

SkillEndorsementCount(x, z, count<y>) :-

Edge(h, “endorsee”, x),
Edge(h, “endorser”, y),
Edge(h, “skill”, z).

HighlySkilled(x, z) :-

SkillEndorsementCount(x, z, c),
Edge(c, “greater_than”, 100).

In the above statement, the “SkillEndorsementCount” rule is used to count, for each “endorsee” represented by “x” and each “skill” represented by “z,” the number of “endorser” edges represented by “y.” A subsequent “HighlySkilled” rule may nest “SkillEndorsementCount” within an additional “Edge” subquery to return results of “SkillEndorsementCount” that have counted values of “endorser” that are greater than 100 (e.g., based on the presence of an edge containing the counted values, a “greater_than” predicate, and an object of “100” in graph database 200).

In another example, a query may include nesting of one aggregation within another aggregation:

EndorsementCountRank(x, rank<c>) :-

EndorsementCount(x, c).

In the above example, the output of the “EndorsementCount” rule is used as input to the “EndorsementCountRank” rule, which generates a numeric ranking of “EndorsementCount” results in descending order of a numeric value “c” that represents the total number of “skill” edges associated with each “endorsee.”

Another exemplary query that includes multiple levels of nesting of aggregations 328 may include the following:

EndorsementCountRowID(x, c, row_id<>) :-

EndorsementCount(x, c).

In the above query, the output of the “EndorsementCount” rule is used as input to the “EndorsementCountRowID” rule, which assigns a unique numeric “row_id” to each result of “EndorsementCount” without ranking the results by another attribute. In turn, the “row_id” attribute may be used to numerically group the results (e.g., into groups of 10, 50, 100, etc.) so that the grouped results can be paginated (e.g., for display in individual web pages or screens of search results or lists).

To enable evaluation of queries 308 that include both nested subqueries 310 and aggregations 328, a transformation apparatus 302 may transform aggregations 328 into edge sets 330 and/or other base terms that can be used as input to additional subqueries 310 in which aggregations 328 are nested. Continuing with the previous example, transformation apparatus 302 may produce the following edges as a query result of the “SkillEndorsementCount” rule:

Edge(h, “grouping_var_1”, x),
Edge(h, “grouping_var_2”, z),
Edge(h, “aggregate_val_1”, c).

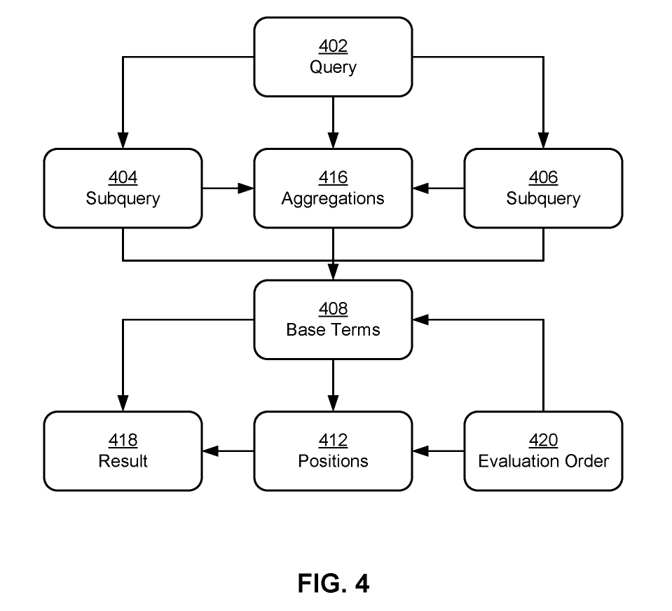

The first edge of the query result may model grouping of the “Endorsement” compound under the “endorsee” predicate, and the second edge of the query result may model grouping of the “Endorsement” compound under the “skill” predicate. The third edge of the query may model counting of the “endorser” predicate under the groupings represented by the first two edges. In turn, the edge representation of the query result may be used as input to additional queries 308 and/or subqueries 310 of graph database 200 during concatenation and/or nesting of queries 308 and/or subqueries 310, as described in further detail below with respect to FIG. 4.

In turn, edge sets 330 representing aggregations 328 may be used during expansion of queries 308 and/or subqueries 310 into base terms that can be evaluated. In particular, transformation apparatus 302 may recursively expand each subquery of a query into edge sets 330 and/or other base terms containing basic types (e.g., nodes 316, edges 318, and/or predicates 320) in graph database 200. Transformation apparatus 302 may also assign, to each base term, a position in an evaluation order for the query. For example, base terms representing an aggregation may be assigned an earlier position in the evaluation order than base terms representing a subquery in which the aggregation is nested. In turn, earlier positions in the evaluation order may be evaluated before later positions in the evaluation order to allow constraints and/or dependencies among the base terms and/or subqueries to be resolved in the evaluation.

After queries 308 are received and optionally transformed, transformation apparatus 302 and/or another query-processing component associated with graph database 200 may use queries 308 and graph database 200 to generate query results 326. For example, the component may use the transformed queries and corresponding evaluation orders to produce query results 326 from aggregations 328 and subqueries 310. The component may then return query results 326 in response to queries 308.

Those skilled in the art will appreciate that the system of FIG. 3 may be implemented in a variety of ways. First, transformation apparatus 302, graph database 200, and/or source of truth 334 may be provided by a single physical machine, multiple computer systems, one or more virtual machines, a grid, one or more databases, one or more filesystems, and/or a cloud computing system. Transformation apparatus 302 and graph database 200 may additionally be implemented together and/or separately by one or more hardware and/or software components and/or layers.

Second, the functionality of transformation apparatus 302 may be used with other types of databases and/or data. For example, transformation apparatus 302 may be configured to transform and/or process queries 308 with aggregations 328 and/or nested subqueries 310 in other systems that support flexible schemas and/or querying.

FIG. 4 shows the processing of a query 402 of a graph database in accordance with the disclosed embodiments. Query 402 may include a number of subqueries 404-406, within which one or more aggregations 416 are specified. For example, query 402 may include one aggregation that is nested within another aggregation. In another example, query 402 may include a first aggregation that is nested within a subquery that performs a non-aggregate operation on the first aggregation. The subquery may then be nested within a second aggregation to apply the second aggregation to the entire subquery result of the subquery.

To evaluate query 402, subqueries 404-406 and aggregations 416 may be recursively expanded until query 402 is transformed entirely into a set of base terms 408, such as edges in the graph database. In addition, aggregations 416 may be transformed into “non-aggregated” sets of edges, as well as edge representations of aggregations 416 that are applied to the non-aggregated edge sets to produce aggregate results of aggregations 416.

Positions 412 in an evaluation order 420 for query 402 may then be assigned to base terms 408, and base terms 408 may be evaluated according to the assigned positions 412 to produce a result 418 of query 402. More specifically, positions 412 may be assigned so that base terms related to an aggregation are evaluated before base terms related to a subquery within which the aggregation is nested because evaluation of the subquery depends on the aggregation result of the aggregation. Finally, base terms 408 may be evaluated according to their assigned positions 412 in evaluation order 420, and aggregation results of aggregations 416 and/or subquery results of subqueries 404-406 represented by base terms 408 may be combined until a final result 418 of query 402 is produced.

For example, query 402 may include the following:

HighlySkilled(a, b)?

The “HighlySkilled” schema described above may be used to perform an initial expansion of the query into the following:

SkillEndorsementCount(a, b, c),
Edge(c, “greater_than”, 100).

Next, the “SkillEndorsementCount” schema discussed above may be used to perform a subsequent expansion of “SkillEndorsementCount” into the following “non-aggregate” edge set:

Edge(h, “endorsee”, a),
Edge(h, “endorser”, b),
Edge(h, “skill”, z).

At the same time, an aggregation operator may be used to transform the aggregation of “c” in “SkillEndorsementCount” into the following set of base terms:

Edge(h, “grouping_var_1”, a),
Edge(h, “grouping_var_2”, b),
Edge(h, “aggregate_val_1”, c).

The first base term may specify the use of “a” and “b” as grouping attributes for “SkillEndorsementCount” and the use of “c” as an aggregation attribute for “SkillEndorsementCount.” After the subsequent expansion is carried out, query 402 may be transformed into three sets of base terms 408: the non-aggregate edge representation of “SkillEndorsementCount,” the edge representation of the “count” aggregation in “SkillEndorsementCount,” and the final “greater_than” edge in “HighlySkilled.”

Positions 412 in evaluation order 420 may then be assigned to base terms 408. In particular, the “non-aggregate” edges of “SkillEndorsementCount” may be assigned the earliest position in evaluation order 420, the edge representation of the aggregation in “SkillEndorsementCount” may be assigned to a middle position in evaluation order 420 (because the aggregation is applied to the resolved non-aggregate edges), and the “greater_than” edge may be assigned to the last position in evaluation order 420 (because the edge depends on the aggregation result of the aggregation).

Finally, base terms 408 in query 402 may be evaluated according to the three assigned positions 412 in evaluation order 420. First, the “non-aggregate” edges of “SkillEndorsementCount” may be resolved to obtain multiple sets of three edges that share a common subject “h” and have different combinations of values for “endorsee,” “endorser,” and “skill.” Next, the aggregate edge terms in the middle position of evaluation order 420 may be applied to the non-aggregate edges so that the edges are grouped by “endorsee” and “endorser” and subsequently aggregated (e.g., counted) by “skill.” The aggregated values may then be used to as input to resolve the final “greater_than” edge in “HighlySkilled.”

In turn, result 418 may include the following exemplary set of edges:

Edge(“h1”, “grouping_var_1”, “Alice”),
Edge(“h1”, “grouping_var_2”, “C++”),
Edge(“h1”, “aggregate_val_1”, “199”),
Edge(“199”, “greater_than”, 100).

The first two edges of result 418 may indicate grouping of a set of edges under a value of “Alice” connected to the “endorsee” predicate and a value of “C++” connected to the “skill” predicate. The third edge of result 418 may specify a value of “199” for the count of “endorser” edges under the grouped values, and the fourth edge of result 418 may link the same value to “100” using the “greater_than” predicate.

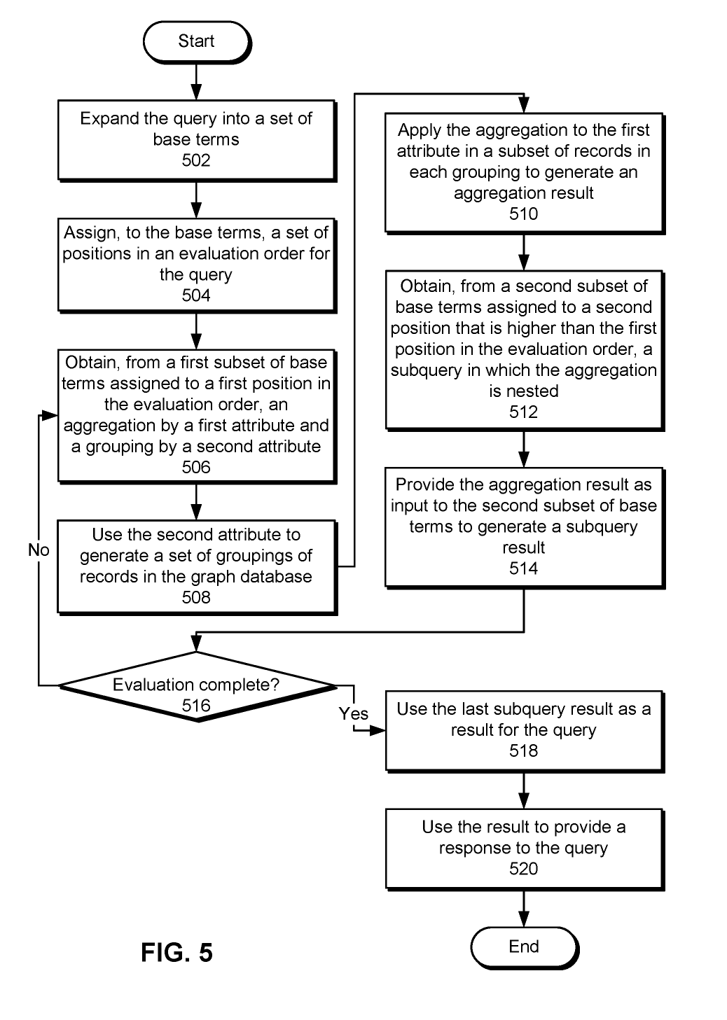

FIG. 5 shows a flowchart illustrating the processing of a query of a graph database in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, the query is expanded into a set of base terms (operation 502). For example, one or more schemas associated with compound and/or rule declarations in the query may be used to transform the query into edge sets containing the base terms. Each aggregation in the query may additionally be transformed into a “non-aggregate” form containing a set of edges that is required to perform the aggregation, as well as an edge representation of the aggregation that is applied to the non-aggregate edge set.

Next, a set of positions in an evaluation order for the query is assigned to the base terms (operation 504). For example, base terms used to evaluate an aggregation in the query may be assigned an earlier position in the evaluation order than base terms used to evaluate a sub-query in which the aggregation is nested. Similarly, a set of edges to which the aggregation is applied may be assigned an earlier position than base terms containing an edge representation of the aggregation.

The base terms are then evaluated according to the positions in the evaluation order. During evaluation of the base terms, an aggregation by a first attribute and a grouping by a second attribute are obtained from a first subset of base terms assigned to a first position in the evaluation order (operation 506). The second attribute is used to generate a set of groupings of records in the graph database (operation 508), and the aggregation is applied to the first attribute in a subset of records in each grouping to generate an aggregation result (operation 510). For example, the “EndorsementCount” schema described above may be used to group the records by “endorsee” and count the number of “skill” edges for each “endorsee.”

After the aggregation is evaluated, a subquery in which the aggregation is nested is obtained from a second subset of base terms assigned to a second position that is higher than the first position in the evaluation order (operation 512). The aggregation result is then provided as input to the second subset of base terms to generate a subquery result (operation 514) for the subquery. For example, the aggregation result may be produced as a subgraph of the graph stored in the graph database (i.e., a set of edges). Because the aggregation result maintains the basic structure of the graph database, the subquery may be applied directly to the aggregation result to produce a subquery result in the same format. Consequently, formatting of the aggregation result as a subgraph and/or set of edges may allow for arbitrary nesting of aggregations and subqueries in the query.

Operations 506-514 may be repeated until evaluation of the query is complete (operation 516). For example, aggregation results and/or subquery results from earlier positions in the evaluation order may be provided as input to aggregations and/or subqueries in later positions in the evaluation order until all base terms in the query have been evaluated. Finally, the last subquery result from the evaluation is used as a result for the query (operation 518), and the result is used to provide a response to the query (operation 520). For example, the result may include edges providing information related to counts, sums, maximums, minimums, averages, percentiles, paginations, and/or other aggregate operations supported by the graph database.

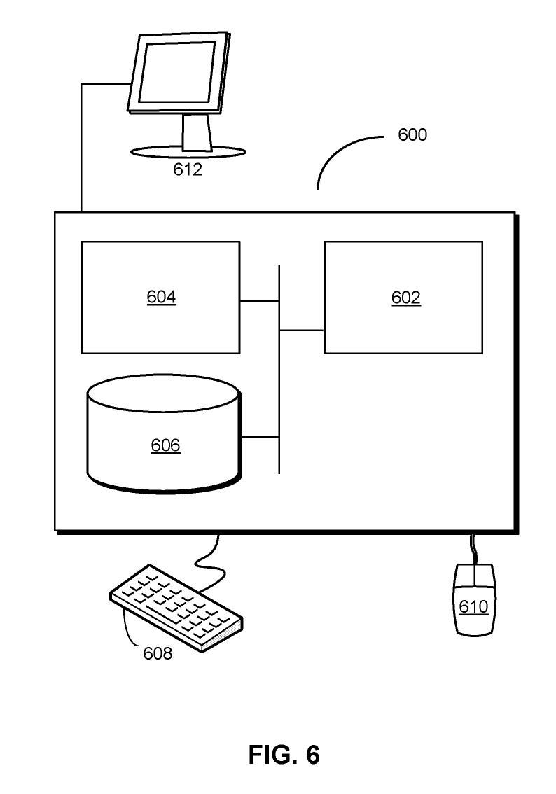

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing queries of a graph database. The system includes a transformation apparatus and a processing apparatus, one or both of which may alternatively be termed or implemented as a module, mechanism, or other type of system component. The transformation apparatus may expand the query into a set of base terms and assign, to the base terms, a set of positions in an evaluation order for the query. The processing apparatus may obtain, from the query and/or base terms, an aggregation by a first attribute and a grouping by a second attribute. Next, the processing apparatus may use the second attribute to generate a set of groupings of records in the graph database. For each grouping in the set of groupings, the processing apparatus may apply the aggregation to the first attribute in a subset of the records in the grouping to generate an aggregation result. The processing apparatus may then use the aggregation result to provide a response to the query.

In addition, one or more components of computer system 600 may be remotely located and connected to the other components over a network. Portions of the present embodiments (e.g., transformation apparatus, processing apparatus, graph database, etc.) may also be located on different nodes of a distributed system that implements the embodiments. For example, the present embodiments may be implemented using a cloud computing system that transforms and evaluates queries with aggregations and nested subqueries in a remote graph database.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
executing a set of processes for processing queries of a graph database storing a graph, wherein the graph comprises a set of nodes, a set of edges between pairs of nodes in the set of nodes, and a set of predicates; and
when a query of the graph database is received, using one or more of the processes to process the query by:
obtaining, from the query, an aggregation by a first attribute and a grouping by a second attribute;
using the second attribute to generate a set of groupings of records in the graph database;
for each grouping in the set of groupings, applying the aggregation to the first attribute in a subset of the records in the grouping to generate an aggregation result; and
using the aggregation result to provide a response to the query.

2. The method of claim 1, further comprising:
expanding the query into a set of base terms comprising the aggregation and the grouping prior to generating the aggregation result.

3. The method of claim 2, further comprising:
assigning, to the base terms, a set of positions in an evaluation order for the query; and
evaluating the base terms according to the positions in the evaluation order.

4. The method of claim 3, wherein assigning the set of positions in the evaluation order to the base terms comprises:
assigning a first position in the evaluation order to a first subset of the base terms comprising the aggregation; and
assigning a second position that is later than the first position in the evaluation order to a second subset of the base terms comprising a subquery in which the aggregation is nested.

5. The method of claim 4, wherein assigning the set of positions in the evaluation order to the base terms further comprises:
assigning a third position that is earlier than the first position to a third subset of the base terms comprising a set of edges to which the aggregation is applied.

6. The method of claim 4, wherein evaluating the base terms according to the positions in the evaluation order comprises:
evaluating the first subset of the base terms to obtain the aggregation result; and
providing the aggregation result as input to the second subset of the base terms.

7. The method of claim 2, wherein the set of base terms comprises a set of edges.

8. The method of claim 2, wherein expanding the query into the set of base terms comprises:
using a schema to transform one or more terms in the query into the set of base terms.

9. The method of claim 1, wherein generating the aggregation result comprises:
producing the aggregation result as a subgraph of the graph.

10. The method of claim 1, wherein the aggregation is at least one of:
a count;
a sum;
a maximum;
a minimum;
an average; and
a percentile.

11. The method of claim 1, wherein the aggregation is at least one of:
a rank; and
a pagination.

12. An apparatus, comprising:
one or more processors; and
memory storing instructions that, when executed by the one or more processors, cause the apparatus to:
execute a set of processes for processing queries of a graph database storing a graph, wherein the graph comprises a set of nodes, a set of edges between pairs of nodes in the set of nodes, and a set of predicates; and
when a query of the graph database is received, use one or more of the processes to process the query by:
obtaining, from the query, an aggregation by a first attribute and a grouping by a second attribute;
using the second attribute to generate a set of groupings of records in the graph database;
for each grouping in the set of groupings, applying the aggregation to the first attribute in a subset of the records in the grouping to generate an aggregation result; and
using the aggregation result to provide a response to the query.

13. The apparatus of claim 12, wherein the memory further stores instructions that, when executed by the one or more processors, cause the apparatus to:
expand the query into a set of base terms comprising the aggregation and the grouping prior to generating the aggregation result.

14. The apparatus of claim 13, wherein the memory further stores instructions that, when executed by the one or more processors, cause the apparatus to:
assign, to the base terms, a set of positions in an evaluation order for the query; and
evaluate the base terms according to the positions in the evaluation order.

15. The apparatus of claim 14, wherein assigning the set of positions in the evaluation order to the base terms comprises:
assigning a first position in the evaluation order to a first subset of the base terms comprising the aggregation; and
assigning a second position that is later than the first position in the evaluation order to a second subset of the base terms comprising a subquery in which the aggregation is nested.

16. The apparatus of claim 15, wherein evaluating the base terms according to the positions in the evaluation order comprises:
evaluating the first subset of the base terms to obtain the aggregation result; and
providing the aggregation result as input to the second subset of the base terms.

17. The apparatus of claim 13, wherein expanding the query into the set of base terms comprises:
using a schema to transform one or more terms in the query into the set of base terms.

18. The apparatus of claim 12, wherein generating the aggregation result comprises:
producing the aggregation result as a subgraph of the graph.

19. A system, comprising:
a graph database storing a graph, wherein the graph comprises a set of nodes, a set of edges between pairs of nodes in the set of nodes, and a set of predicates; and
a processing module comprising a non-transitory computer-readable medium comprising instructions that, when executed, cause the system to process a query of the graph database by:
obtaining, from the query, an aggregation by a first attribute and a grouping by a second attribute;
using the second attribute to generate a set of groupings of records in the graph database;
for each grouping in the set of groupings, applying the aggregation to the first attribute in a subset of the records in the grouping to generate an aggregation result; and
using the aggregation result to provide a response to the query.

20. The system of claim 19, wherein the non-transitory computer-readable medium of the processing module further comprises instructions that, when executed, cause the system to:
expand the query into a set of base terms comprising the aggregation and the grouping prior to generating the aggregation result;
assign, to the base terms, a set of positions in an evaluation order for the query; and
evaluate the base terms according to the positions in the evaluation order.
